(19) United States
(12) Patent Application Publication
(10) Pub. No.: US 2016/0158668 A1
(43) Pub. Date: Jun. 9, 2016

(54) ADSORPTION SEPARATION UNIT HAVING VALVE WITH INTEGRAL BLEED LINE

(71) Applicant: UOP LLC, Des Plaines, IL (US)

(72) Inventor: Casey Cummings, Des Plaines, IL (US)

(21) Appl. No.: 14/561,849

(22) Filed: Dec. 5, 2014

(51) Int. Cl. B01D 15/14; F16K 1/16; B01D 15/18

(52) U.S. Cl. CPC B01D 15/14; B01D 15/1821; B01D 15/1842; F16K 1/16

(57) ABSTRACT

An adsorption separation unit and process. Valves are used to provide positive isolation between the various components of the unit, for example, when maintenance is required or when repairs are to be made. The valves comprises a first sealing element, a second sealing element and a bleed space between the sealing elements. A valve in a bleed line can be used to drain any fluid in the bleed space when the sealing elements are position in the sealing position.

### FIELD OF THE INVENTION

This invention relates generally to an adsorption separation unit having one or more valves with an integral bleed line, and more particularly to an adsorption separation unit having such a valve in the lines associated with the adsorbent beds of the adsorption separation unit.

### BACKGROUND OF THE INVENTION

Refiners and other chemical processors are often faced with separating a feed mixture of various hydrocarbons into one or more relatively pure streams. One method of separating a component or group of components from a mixture is selective adsorption on a solid adsorbent. An example of such an adsorption process involves a continuous process in which feed and products enter and leave the adsorbent bed at substantially constant composition. The process simulates the countercurrent flow of a liquid feed over a solid bed of adsorbent without physically moving the solid by moving the injection and withdrawal points along the bed. As the concentration profile moves down the column, the injection and withdrawal points also move. The adsorbent-desorbent combination depends on the materials being separated.

Such a process usually takes places in an adsorption separation unit. As will be appreciated, there are times when it is necessary to isolate sections of the unit—for example when the unit is shut down, for maintenance, to replace adsorbent, or to repair a broken piece of equipment. In order to maintain the positive isolation between the pieces of equipment, the units include multiple double-block and bleed valve configurations. These double-block and bleed valve configurations comprise two inline block valves and a bleed (or vent) valve. A length of conduit will separates the two inline block valves. Additionally, a T-connection may be required for the bleed line and valve. In order to close the entire configuration, each inline block valve must be closed, and then the bleed or vent valve can be opened to vent the conduit and space between the valves.

While these valves configurations are effective for their intended purposes, due to the number of locations in various adsorption separation units, the use of these valve configurations can be quite costly. Additionally, with the increased number of valves, the potential for leakage and the amount of required maintenance increases. Finally, such valve configurations include a large volume of dead space between the two inline valves, increasing the quantity of process fluid to be handled during maintenance.

It would be desirable to provide an adsorption separation unit that includes a valve configuration that provides the desired positive isolation without such a large dead space. Additionally, it would be desirable to have such a configuration that lowers the capital expenditures associated with an adsorption separation unit, increases safety by decreasing the number of potential leakage points, and decreases maintenance by reducing the number of installed valves.

### SUMMARY OF THE INVENTION

A new adsorption separation unit has been invented which utilizes an integral bleed line between two sealing surfaces. This will allow a single (or in some instances two valves) to be used instead of the traditionally used three valve double block and bleed system. The lower number of valves may lower the maintenance and potential for leakage. Such valves may also lower the capital cost of such a unit. Finally, such valves have a lower dead volume between sealing surfaces for the bleed line.

In a first aspect of the present invention, the present invention may be broadly characterized as providing a simulated moving bed unit comprising: a vessel including a plurality of ports; a distributor configured to distribute at least two fluids to beds of the vessel; a plurality of conduits; and, at least one valve. The ports are disposed at different vertical positions on the vessel and each port is associated with a different bed having an adsorbent. Each port is in communication with the distributor via a conduit. The at least one valve is disposed in a conduit from the plurality of conduits and comprises a first sealing surface, a second sealing surface and a bleed line disposed between the first and second sealing surfaces. The first sealing surface and the second sealing surface are housed within a single body.

In one or more embodiments, the distributor comprises a rotary valve. It is contemplated that the simulated moving bed unit further comprises a plurality of valves and each valve from the plurality of valves comprises a first sealing surface, a second sealing surface and a bleed line disposed between the first and second sealing surfaces, and both the first sealing surface and the second sealing surface are contained within a single housing. It is also contemplated that each conduit has a first end disposed proximate the port of the vessel and a second end disposed proximate the rotary valve, and each end of the conduit includes a valve from the plurality of valves. It is further contemplated that the valves from the plurality of valves each include an actuator. The actuator may be in communication with both the first sealing surface and the second sealing surface.

In some of the embodiments, the bleed line includes a bleed valve. It is contemplated that the bleed valve of the bleed line is integral with the valves from the plurality of valves.

In at least one embodiment, the simulated moving bed unit further comprises: a second vessel including a plurality of beds and each bed being associated with a port, the ports being disposed at different vertical positions on the second vessel, wherein each port on the second vessel is in communication with the distributor via a conduit; and, wherein each conduit includes at least one valve comprising a first sealing surface, a second sealing surface and a bleed line disposed between the first and second sealing surfaces, wherein both the first sealing surface and the second sealing surface are housed within a single body. It is contemplated that the distributor comprises a rotary valve. It is further contemplated that each vessel includes between eight and sixteen beds. It is likewise contemplated that each vessel includes twelve beds. It is also contemplated that the valves from the plurality of valves each include an actuator. It is further contemplated that the actuator is in communication with both the first sealing surface and the second sealing surface. It is even further contemplated that the bleed line includes a bleed valve. It is also contemplated that the bleed valve of the bleed line is integral with the valves from the plurality of valves.

In a second aspect of the present invention, the invention may be broadly characterized as providing a simulated moving bed unit comprising: a plurality of vessels, each vessel comprising a bed and each bed being in communication with a port; a distributor configured to distribute process fluids to the vessels and receive process fluids from the vessels; a plurality of conduits disposed between the ports and the distributor; and, a plurality of valves. Each valve from the plurality of valves is disposed within a conduit from the plurality of conduits. Each valve comprises a first sealing surface, a second sealing surface and a bleed line disposed between the first and second sealing surfaces, and both the first sealing surface and the second sealing surface are housed within a single body.

In various embodiments, each vessel includes twelve beds.

In some of the embodiments, the bleed line of each valve includes a bleed valve and the bleed line is integral with the valve.

In at least one embodiment, the valves from the plurality of valves each include an actuator in communication with both the first sealing surface and the second sealing surface.

Additional aspects, embodiments, and details of the invention are set forth in the following detailed description of the invention.

### DETAILED DESCRIPTION OF THE DRAWINGS

In the drawings of the present invention, one or more embodiments are shown in which like numerals denote like elements and in which:

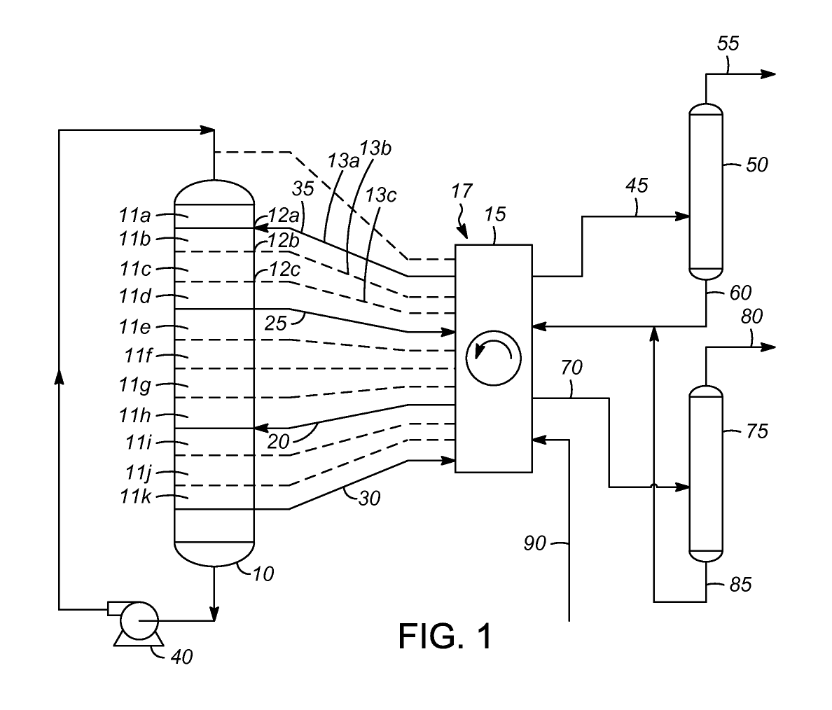

FIG. 1 shows an illustration of an adsorption process and unit that may be used in accordance with the present invention;

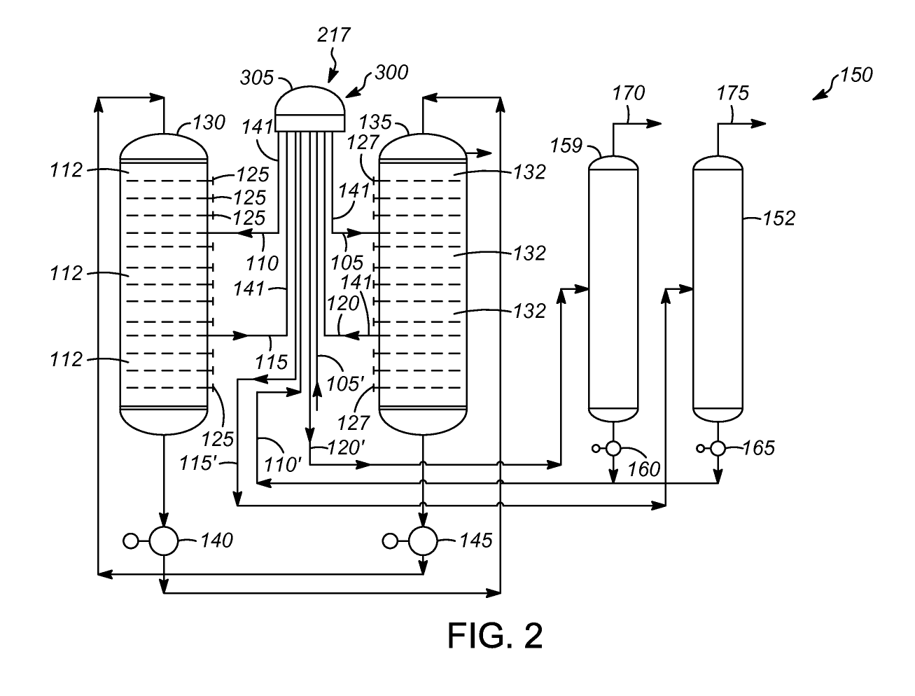

FIG. 2 shows another illustration of an adsorption process and unit that may be used in accordance with the present invention; and

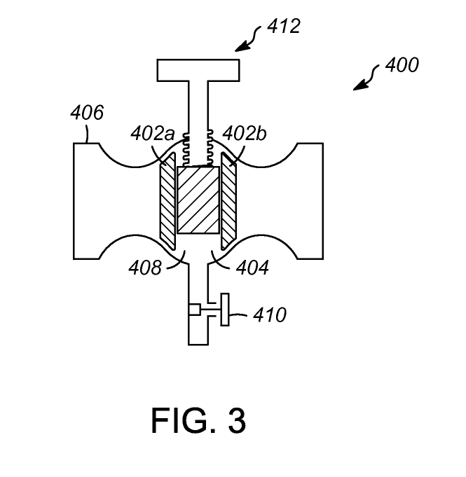

FIG. 3 shows a cutaway view of an exemplary valve used in accordance with the present invention.

### DETAILED DESCRIPTION OF THE INVENTION

A new adsorption separation unit and a process of operating same have been invented. The new adsorption separation unit includes at least one, preferably a plurality, valve that include a first and second sealing surface with a bleed or vent space or line disposed between. Such valves will provide the required positive isolation when the valve is sealed, but will not include the increased costs associated with the conventional configurations having two inline valves and a third bleed valve. Additionally, there is less dead volume in such valves compared with the conventional configurations. Finally, such valves may have fewer leakage points and may require less maintenance.

With this general description, one or more embodiments of the present invention will now be described with the understanding that these embodiments are merely exemplary.

As indicated above, the present is particularly directed to an adsorption separation unit and a process of operating same. FIG. 1 illustrates an example of an adsorption process in which separation occurs in the adsorbent vessel 10. The adsorbent vessel 10 is separated into a number of beds 11a-11k, located at a different vertical position within the vessel 10. Additionally, each bed 11a-11k is associated with a port 12a-12k. A conduit 13a-13k connects each bed 11a-11k to a distributor 17. As will appreciated to the skilled practitioner, for clarity purposes only ports 12a, 12b, 12c and conduits 13a, 13b, 13c are labeled.

The distributor 17, via ports 12a-12k and conduits 13a-13k, injects or withdraws liquid from the adsorbent vessel 10, or redistribute liquid around the adsorbent vessel 10. There are four major streams distributed to and from the adsorbent vessel 10 by the distributor 17, in this case a rotary valve 15. The feed inlet stream 20 includes a raw mixture of all of the feed components. A dilute extract out stream 25 includes a selectively adsorbed component or components diluted with desorbent. The dilute raffinate out stream 30 includes rejected components diluted with desorbent. The desorbent in stream 35 is the recycled desorbent separated from the extract and raffinate. Only four of the conduits 13a-13k are carrying streams into or out of the adsorbent vessel 10 at any given time. Thus, the conduits 13a-13k shown in dashed are conduits between the rotary valve 15 and the adsorbent vessel 10 that are not in use while four other lines are being used for the various process streams. As will be appreciated, these conduits 13a-13k switch and change based upon the flow and location of the process fluids.

A pump around pump 40 circulates process liquid from the adsorbent bed at the bottom of the adsorbent chamber 10 to the bed at the top. The concentration profile in the adsorbent vessel 10 moves down past the last bed 11k, through the pump around pump 40 and up to the top. The actual liquid flow rate through the zones is different because the rate of injection and withdrawal of the streams is different. The overall liquid circulation is controlled by the pump around pump 40 and a flow control valve (not shown). The dilute extract stream 45 from the rotary valve 15 is sent to an extract column 50 where an extract stream 55 is separated from a desorbent stream 60. The extract stream 55 is then recovered. The desorbent stream 60 is recycled to the rotary valve 15 for use in the process. The dilute raffinate stream 70 is sent to a raffinate column 75 where a raffinate stream 80 is separated from a desorbent stream 85. The desorbent stream 85 is combined with the desorbent stream 60 and recycled to the process. The raffinate stream 80 is removed. A feed stream 90 is sent to the rotary valve 15 for use in the process. Further detailed information about such a unit and a process are known in the art and not necessary for the understanding or practicing of the present invention.

It is also known to utilize two adsorbent chambers as illustrated in FIG. 2. In one approach, the adsorption separation unit 150 simulates countercurrent movement of the adsorbent and surrounding liquid, but it may also be practiced in a co-current continuous process. Both of these systems are well known in the art. Countercurrent moving-bed or simulated-moving-bed countercurrent flow systems have a much greater separation efficiency for such separations than fixed-bed systems, as adsorption and desorption operations are continuously taking place with a continuous feed stream and continuous production of extract and raffinate.

The adsorption separation process of unit 150 sequentially contacts a feed stream 105 with adsorbent contained in the vessels 130, 135 and a desorbent stream 110 to separate an extract stream 115 and a raffinate stream 120. In the simulated-moving-bed countercurrent flow system, progressive shifting of multiple liquid feed and product access points or ports 125 down the adsorbent chambers within the vessels 130, 135 simulate the upward movement of adsorbent contained in the chamber. The adsorbent in a simulated-moving-bed adsorption process is contained in multiple beds in the vessels 130, 135 or chambers.

Each vessel 130, 135 contains multiple beds 112, 132 of adsorbent in processing spaces and a number of ports 125, 127 relating to the number of beds of adsorbent, each bed 112, 132 being located at a different vertical position in the respective vessels 130, 135. Additionally, as will be appreciated conduits 141 between each of the ports 125 and a distributor 217 are not shown other than those for the feed stream 105, desorbent stream 110, extract stream 115 and raffinate stream 120 are shifted along the ports 125, 127 to simulate a moving adsorbent bed. Circulating liquid comprising desorbent, extract, and raffinate circulates through the chambers through pump around pumps 140 and 145, respectively. Systems to control the flow of circulating liquid are described in U.S. Pat. No. 5,595,665, but the particulars of such systems are not essential to the present invention. The rotary disc type valve 300, for example as disclosed in U.S. Pat. No. 8,752,556, effects the shifting of the streams along the adsorbent chamber to simulate countercurrent flow. The distributor 217 may comprise a rotary disc valve 300; however other systems and apparatus for shifting the streams along the adsorbent chamber are also contemplated herein, including systems utilizing multiple valves to control the flow of the streams to and from the vessels 130, 135.

As will be appreciated, the extract stream 115 and the raffinate stream 120 in the illustrated schemes contain desorbent in concentrations relative to the respective product from the process of between 0% and 100%. The desorbent generally is separated from raffinate and extract components by conventional fractionation in, respectively, raffinate column 159 and extract column 152 as illustrated in FIG. 2 and recycled to a stream 110′ by raffinate column bottoms pump 160 and extract column bottoms pump 165 to be returned to the process. Although depicted with the desorbent as bottoms from the respective column, however in some applications the desorbent may be separated at a different location along the fractionation columns 152, 159. The raffinate product 170 and the extract product 175 from the process are recovered from the raffinate stream and the extract stream in the respective columns 159, 152. The extract product 175 from the separation of C8 aromatics usually comprises principally one or both of para-xylene and meta-xylene, with the raffinate product 170 being principally non-adsorbed C8 aromatics.

As mentioned above, these units and processes must be shut down occasionally for example for maintenance or for repair, or have troubleshooting investigations performed. In order to maintain positive isolation between the various lines, conduits, vessels, and pumps, a double-block and bleed valve configuration is used in the various lines and conduits so that each bed, pump, and other piece of equipment can be isolated. In accordance with the present invention, preferably a single valve is used to replace the multi-valve double-block and bleed valve configuration. FIG. 3 shows an exemplary valve 400 that can be used.

The valve 400 can be any type of valve that includes two sealing elements 402a, 402b spaced apart with a bleed or vent line 404 there between. For example, ball, gate, butterfly, or plug valves are all valves that may be used. Both the first sealing surface 402a and the second sealing surface 402b are housed or contained within a body 406. At least a portion of the bleed line 404 is also contained within the body 406. In other words, a void 408 exists between the first sealing surface 402a and the second sealing surface 402b within the body 406. The valve 400 may include a valve 410 associated with the bleed line 404. The valve 410 in the bleed line 404 may be integral with the body 406, or it may be a separate or self-contained valve.

In order to close the valve 400, an actuator or actuating member 412 is used. For example, the actuating member 412 may comprise handles, rotating wheels with a threaded shaft, levers, or other similar structures, as well as pneumatic or hydraulic actuators that can be automated. Preferably, the actuating member 412 is in communication with both sealing surfaces 402a, 402b. For example, the actuating member 412 can be rotated to move the sealing surfaces 402a, 402b into a sealing position that precludes the flow of fluid through the valve 400. The valve 410 in the bleed line 404 can be opened to allow any fluid (vapor or liquid) that is contained within the void 408 to be removed. Once the isolation is no longer required, the valve 410 on the bleed line can be closed, and the actuating member 412 can be rotated to move the sealing surfaces 402a, 402b out of their respective sealing positions and allowing the flow of fluid through the valve 400.

The valve 400 may be used at any number of positions within the processes and units shown in FIGS. 1 and 2. For example, with respect to FIG. 1, a valve 400 is preferably disposed within each of the conduits 13a-13k proximate the ports 12a-12k on the adsorbent vessel 10. Furthermore, the valves 400 may be disposed proximate the rotary valve 15 on each of the conduits 13a-13k communicating with the port

With respect to the unit in FIG. 2, again a valve 400 is preferably disposed within each of the conduits proximate the ports 125 on both of the adsorbents vessel 130, 135. Furthermore, the valves 400 may be disposed proximate the rotary valve 300 on each of the conduits 13a-13k.

As will be appreciated, in units in which there are numerous conduits or lines between the beds in the adsorbent vessels and a distribution member such as a rotary valve, the use of these valves as described herein will lower the total number of valves needed for the entire unit. By minimizing the number of separated valves, the cost associated with such a unit is believed to be lower. Furthermore, there will be less connections, and seals that have the potential to leak and require maintenance.

It should be appreciated and understood by those of ordinary skill in the art that various other components such as other valves, pumps, filters, coolers, etc. were not shown in the drawings as it is believed that the specifics of same are well within the knowledge of those of ordinary skill in the art and a description of same is not necessary for practicing or understating the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A simulated moving bed unit, the simulated moving bed unit comprising:
a vessel including a plurality of ports, the ports being disposed at different vertical positions on the vessel and each being associated with a different bed having an adsorbent;
a distributor configured to distribute at least two fluids to the beds of the vessel;
a plurality of conduits, each port being in communication with the distributor via a conduit; and,
at least one valve, the at least one valve being disposed in a conduit from the plurality of conduits, wherein the at least one valve comprises a first sealing surface, a second sealing surface and a bleed line disposed between the first and second sealing surfaces, wherein both the first sealing surface and the second sealing surface are housed within a single body.

2. The simulated moving bed unit of claim 1 wherein the distributor comprises a rotary valve.

3. The simulated moving bed unit of claim 2 further comprising a plurality of valves, wherein each valve from the plurality of valves comprises a first sealing surface, a second sealing surface and a bleed line disposed between the first and second sealing surfaces, wherein both the first sealing surface and the second sealing surface are contained within a single housing.

4. The simulated moving bed unit of claim 3 further comprising:
each conduit having a first end disposed proximate the port of the vessel and a second end disposed proximate the rotary valve, and wherein each end of the conduit includes a valve from the plurality of valves.

5. The simulated moving bed unit of claim 4, wherein the valves from the plurality of valves each include an actuator.

6. The simulated moving bed unit of claim 5, wherein the actuator is in communication with both the first sealing surface and the second sealing surface.

7. The simulated moving bed unit of claim 1 wherein the bleed line includes a bleed valve.

8. The simulated moving bed unit of claim 7 wherein the bleed valve of the bleed line is integral with the valves from the plurality of valves.

9. The simulated moving bed unit of claim 1 further comprising:
a second vessel including a plurality of beds and each bed being associated with a port, the ports being disposed at different vertical positions on the second vessel,
wherein each port on the second vessel is in communication with the distributor via a conduit, and
wherein each conduit includes at least one valve comprising a first sealing surface, a second sealing surface and a bleed line disposed between the first and second sealing surfaces, wherein both the first sealing surface and the second sealing surface are housed within a single body.

10. The simulated moving bed unit of claim 9 wherein the distributor comprises a rotary valve.

11. The simulated moving bed unit of claim 10 wherein each vessel includes between eight and sixteen beds. 12 The simulated moving bed unit of claim 10 wherein each vessel includes twelve beds.

13. The simulated moving bed unit of claim 12, wherein the valves from the plurality of valves each include an actuator.

14. The simulated moving bed unit of claim 13, wherein the actuator is in communication with both the first sealing surface and the second sealing surface.

15. The simulated moving bed unit of claim 14 wherein the bleed line includes a bleed valve.

16. The simulated moving bed unit of claim 15 wherein the bleed valve of the bleed line is integral with the valves from the plurality of valves.

17. A simulated moving bed unit, the simulated moving bed unit comprising:
a plurality of vessels, each vessel comprising a bed and each bed being in communication with a port;
a distributor configured to distribute process fluids to the vessels and receive process fluids from the vessels;
a plurality of conduits disposed between the ports and the distributor; and,
a plurality of valves, each valve from the plurality of valves being disposed within a conduit from the plurality of conduits, wherein valve comprises a first sealing surface, a second sealing surface and a bleed line disposed between the first and second sealing surfaces, wherein both the first sealing surface and the second sealing surface are housed within a single body.

18. The simulated moving bed unit of claim 17, wherein each vessel includes twelve beds.

19. The simulated moving bed unit of claim 17 wherein the bleed line of each valve includes a bleed valve and the bleed line is integral with the valve.

20. The simulated moving bed unit of claim 17 wherein the valves from the plurality of valves each include an actuator in communication with both the first sealing surface and the second sealing surface.
